(19) United States
(12) Patent Application Publication
(10) Pub. No.: US 2015/0379973 A1
(43) Pub. Date: Dec. 31, 2015

(54) DRUM HEAD RETAINING AND TUNING SYSTEM

(71) Applicant: William D. Hegdahl, Minnetonka, MN (US)

(72) Inventor: William D. Hegdahl, Minnetonka, MN (US)

(21) Appl. No.: 14/704,404

(22) Filed: May 5, 2015

Related U.S. Application Data
(60) Provisional application No. 61/988,411, filed on May 5, 2014.

(51) Int. Cl. G10D 13/02

(52) U.S. Cl. CPC G10D 13/023

(57) ABSTRACT

An adjustable drum head retaining and tuning system and associated method is disclosed. The system comprises a hoop assembly having a plurality of tension lips, and a plurality of attachment studs secured to a drum shell. The tension lip is sloped and placed on the interior of the hoop assembly. The attachment stud is affixed at even intervals along the exterior of the drum shell. The hoop assembly contains a lip to secure a drum head and is placed over the top of the drum head and aligned with the attachment stud. Rotating the hoop assembly in combination with the tension lip and attachment stud will provide and downward tightening force to the drum head.

### CROSS-REFERENCE TO RELATED APPLICATIONS

The present application claims the benefit of U.S. Provisional Application No. 61/988,411 entitled “Adjustable Drum Head Retaining and Tuning System,” filed May 5, 2014, which is incorporated herein by reference in its entirety.

### FIELD OF THE INVENTION

The present invention relates generally to musical instruments, and more particularly to a retaining device for a drum head.

### BACKGROUND OF THE INVENTION

A typical drum head or skin, as it is sometimes called, is placed over the top or bottom of the drum shell and secured in place using a combination of a hoop, a tension rod, and a tension lug. Several tension lugs are placed equally along the exterior of the drum shell and secured to the shell. The hoop typically contains a series of apertures to receive the tension rod, wherein the tension rod provides a securing force to the hoop to secure the drum head to the shell.

To affix and secure the drum head to the shell, a user will place the properly sized and desired drum head onto the shell. The hoop is then placed over the drum head and secured into place using the tension rod secured within the lug. Often the tension rod is a threaded rod and received within a threaded socket present in the lug. These tension rods are then tightened to secure the drum head.

To tune the drum the tension on the tension rods is adjusted to the desired sound of the user. This requires the user to carefully and systematically adjust each tension rod to the desired tension that provides the appropriate pitch of a batted drum head. This process can be very tedious and must be completed each time a new drum head is installed. Further, as each tension is adjusted individually, it is difficult to ensure consistency in the pitch of the drum with each new installation, requiring a great deal of time, skill and experience to achieve the desired sound.

Therefore, there is a need for a drum head retaining means that is easy to adjust and ensure a consistent tuning of the instrument with each new adjustment and drum head installation.

### SUMMARY OF THE INVENTION

An adjustable drum head retaining and tuning system is disclosed. The drum head retaining means is designed for ease of use and provides consistent, uniform tension to a mounted drum head to quickly and easy tune the drum. The adjustable drum head retaining and tuning system generally comprises a hoop assembly having a plurality of tension lips, and a plurality of attachment studs secured to a drum shell. The hoop assembly is sized to the drum shell and placed over the drum head to secure the drum head to the shell. The hoop assembly includes a lip parallel to the opening of the drum shell and extends down around the opening perpendicular to the shell opening. The hoop assembly is preferably constructed of 12-16 gauge sheet metal that is brake press and roll formed to the appropriate dimensions to accommodate the drum shell and drum head.

The tension lip is placed on the interior of the anti-flex hoop and extends inward from the interior of the hoop assembly and towards the shell of the drum. The tension lip may be orientated on an incline from the lip of the hoop assembly downward towards the end of the hoop assembly opposite the lip, such that the tension lip has a slope or gradient. The tension lip may comprise strap rolled steel and welded to the hoop assembly interior.

The attachment studs are affixed to the drum shell and sized to be received within the hoop assembly and tension lip, wherein the hoop assembly will extend over the length of the attachment stud and be received on the upper side of the tension lip. Accordingly, as the hoop assembly is rotated the attachment stud provides a contact point for the tension lip and allows the tension lip to pull the drum head towards the shell. In combination with the hoop assembly and tension lip, a user can place a drum head onto the shell, place the hoop over the shell, align it with the attachment stud and rotate the hoop assembly. This rotation will tighten the drum head. In an embodiment of the present invention, the attachment stud comprises a cam follower bearing to allow for easy twisting. In one embodiment, at least four attachment studs are placed on opposed sides of the drum at 90 degree angles to provide equal pressure to a mounted drum head. In other embodiments, other arrangements of attachment studs may be used, such as three, five, six, or more as desired.

### BRIEF DESCRIPTION OF THE DRAWINGS

The invention may be more completely understood in consideration of the following detailed description of various embodiments of the invention in connection with the accompanying drawings, in which:

FIG. 1 is an exploded view of an embodiment of the invention.

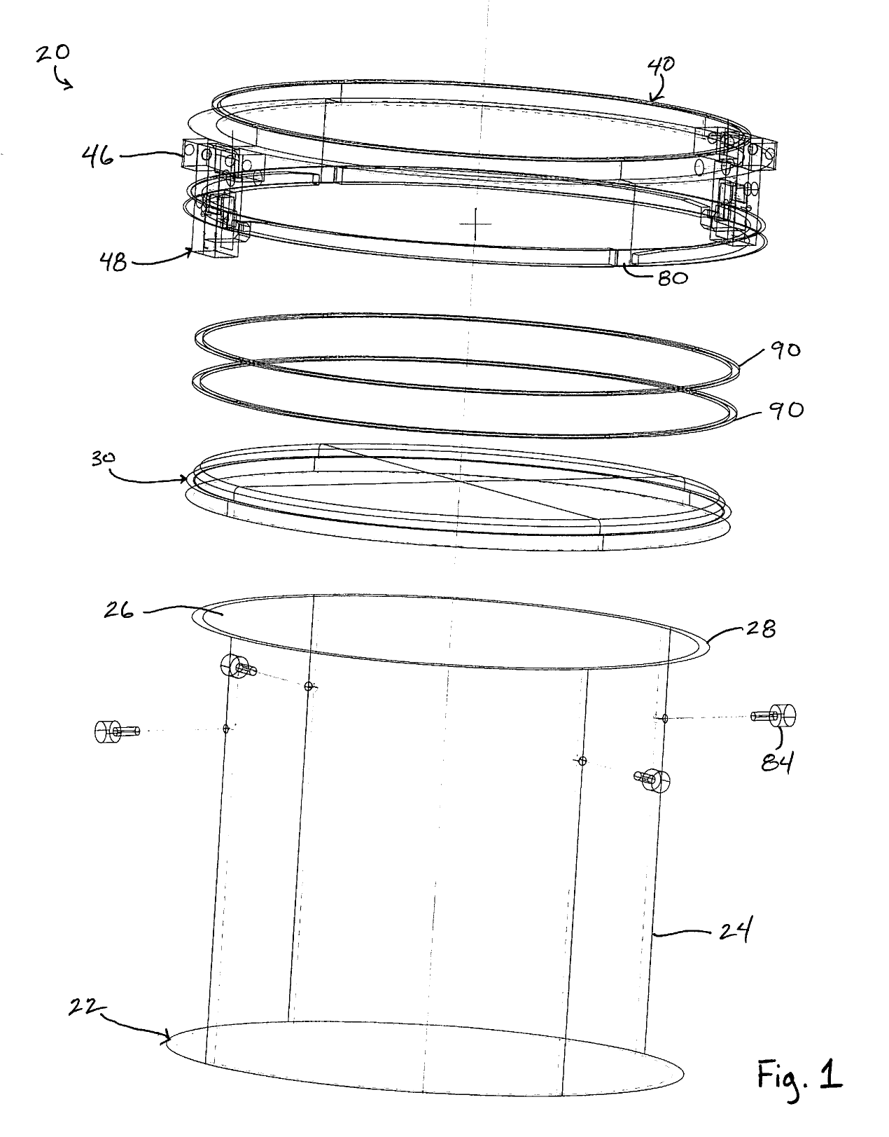

FIG. 2 is an exploded side elevation view of FIG. 1

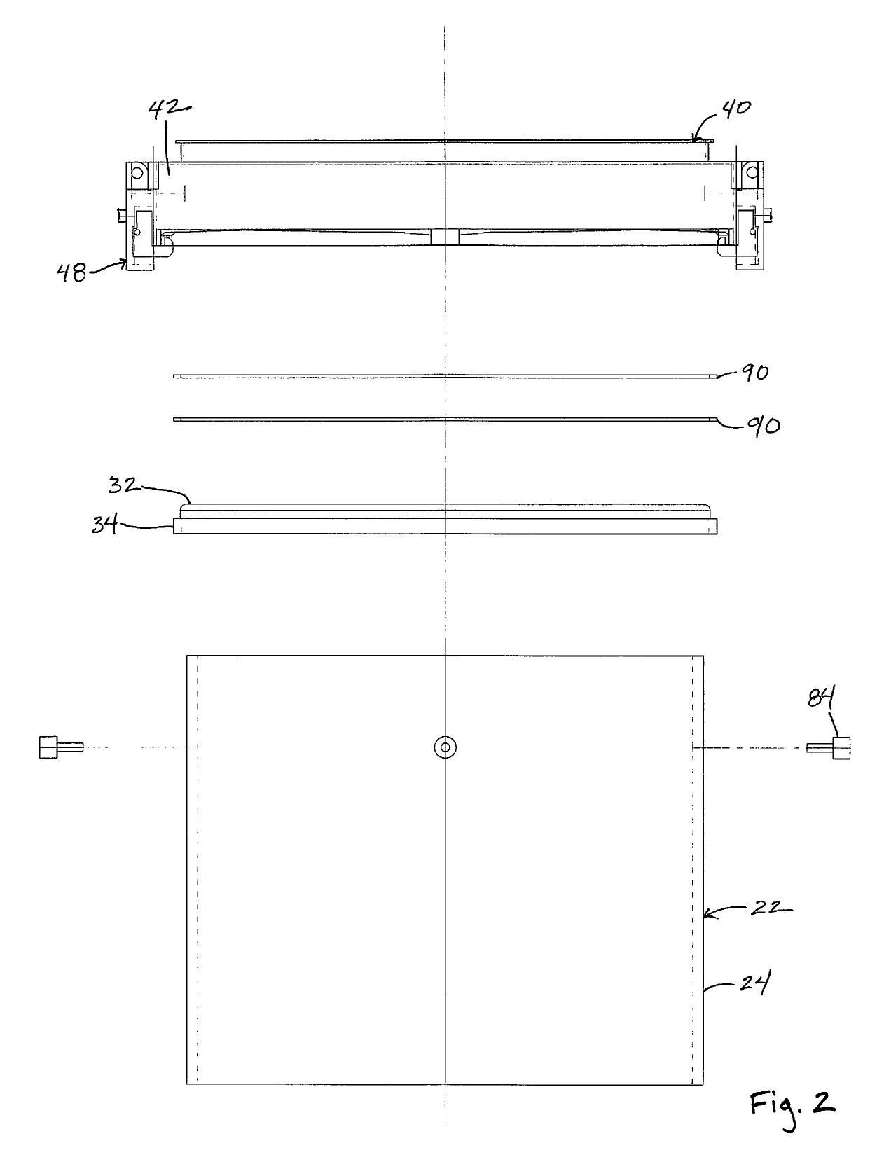

FIG. 3 is a perspective view of a hoop assembly according to an embodiment of the invention.

FIG. 4 is a side elevation view of FIG. 3.

FIG. 5 is a side elevation view of a clamp assembly according to an embodiment of the invention.

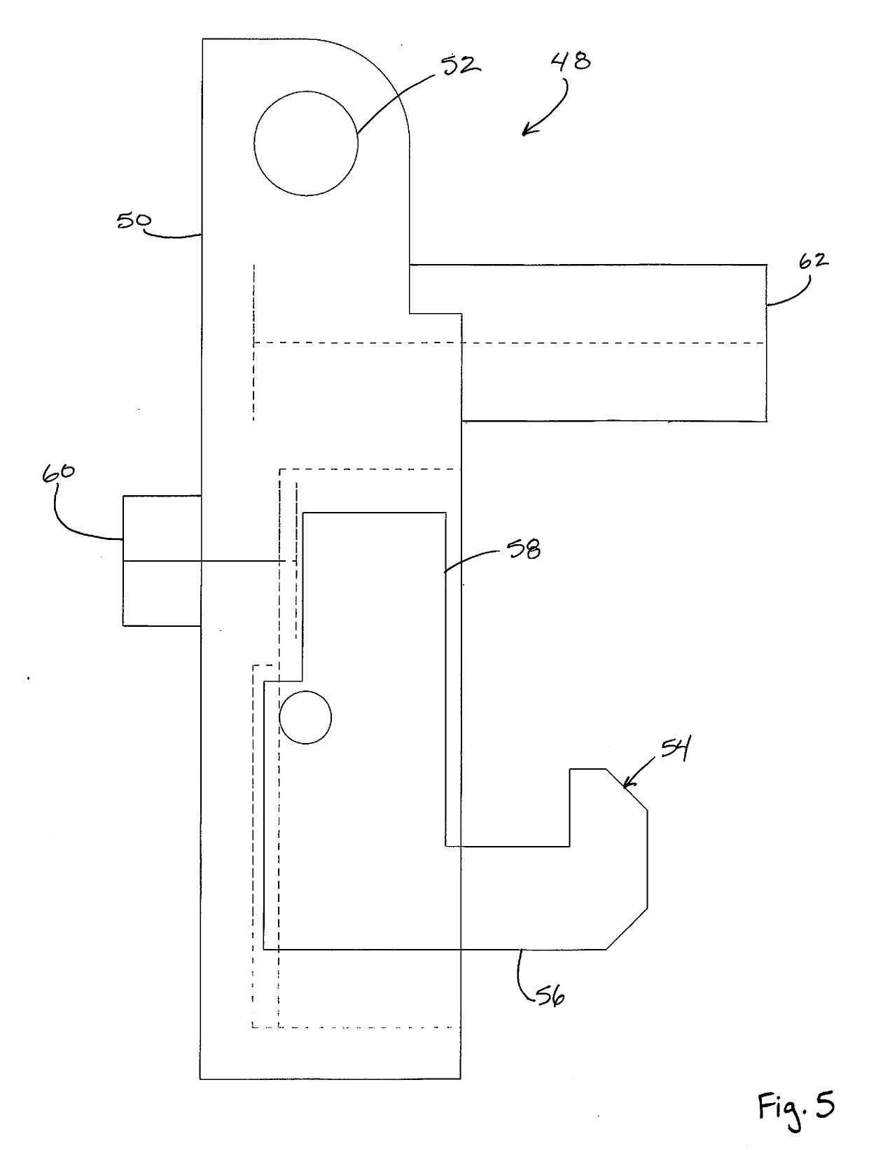

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION OF THE DRAWINGS

The following detailed description should be read with reference to the drawings in which similar elements in different drawings are numbered the same. The drawings, which are not necessarily to scale, depict illustrative embodiments and are not intended to limit the scope of the invention.

Referring generally to the Figures, drum assembly 20 comprises a drum shell 22, a drum head 30, a hoop assembly 40, a plurality of rollers 84 and at least one slip ring 90. Drum shell 22 is of a conventional type, and may comprise a variety of shapes and sizes for different drum styles, as is known in the art. Drum shell 22 generally includes a body 24, an opening 26 on either end, and a bearing edge 28 on each edge. The profile of bearing edge 28 may be varied as desired for different drum styles, as is known in the art.

For simplicity, hoop assembly 40 and associated components are depicted on only one end of the drum in the Figures. It will be understood to persons skilled in the art that the other end of the drum is similarly fitted with a drum head, secured to the drum either by conventional means including mounting lugs and tension rods, or by a second hoop assembly 40 and associated components.

A drum head 30 is provided for each end of drum shell 22, a top or batter head and a bottom or resonant head. Drum head 30 generally includes a skin 32 secured to a rim 34, skin 32 being comprised of natural or synthetic materials.

Hoop assembly 40 generally includes an annular body 42 having an inner shoulder 44, a plurality of brackets 46 secured to an outer portion of body 42, a plurality of claim assemblies 48 pivotably coupled to respective brackets 46, and a plurality of tension lips 70. Hoop assembly 40 is configured to be rotatably and releasably coupled to drum shell 22, to retain drum head 30 thereto. Hoop assembly 40 further provides the ability to adjust the tuning of drum head 30 to obtain a desired sound from drum assembly 20.

Each clamp assembly 48 generally includes a body portion 50, an upper pivot point 52 by which clamp assembly 48 is pivotably coupled to bracket 46, an operable latch means 54 and a retention means 62. Latch means or mechanism 54 is pivotably secured to body 50, and in one embodiment includes a latch portion 56 configured to selectively engage annular body 42, and a release portion 58. A release means 60 is selectively engageable with release portion 58, such that operation of release means 60 causes latch means 54 to pivot and cause latch portion 56 to disengage from annular body 42. Release means 60 may comprise a spring-loaded button which is biased such that depressing the button engages means 60 with release portion 58. Release means 60 may also comprise a lever pivotably coupled to body portion 50 and having a cam portion selectively engageable with release portion 58. Other suitable arrangements for release means 60 are within the spirit and scope of the invention.

Retention means 62 is coupled to, or integrated with, body portion 50 of clamp assembly 48 and is configured to selectively engage rim 34 of drum head 30 so as to retain hoop assembly 40 at a desired position. Retention means 62 may comprise, for example, a stud having an end which is knurled or otherwise configured to increase frictional grip against a surface. A channel or bore 68 is provided in annular body 42 to allow retention means to pass therethrough and selectively engage with drum head rim 34. Retention means 62 may be fixed in place, or may be adjustable so as to provide a tension adjustment. For example, in the case of a retention means 62 comprising a stud, the stud may be threaded into body 50, such that threading the stud in or out will vary the resulting tension against drum head rim 34 from the stud.

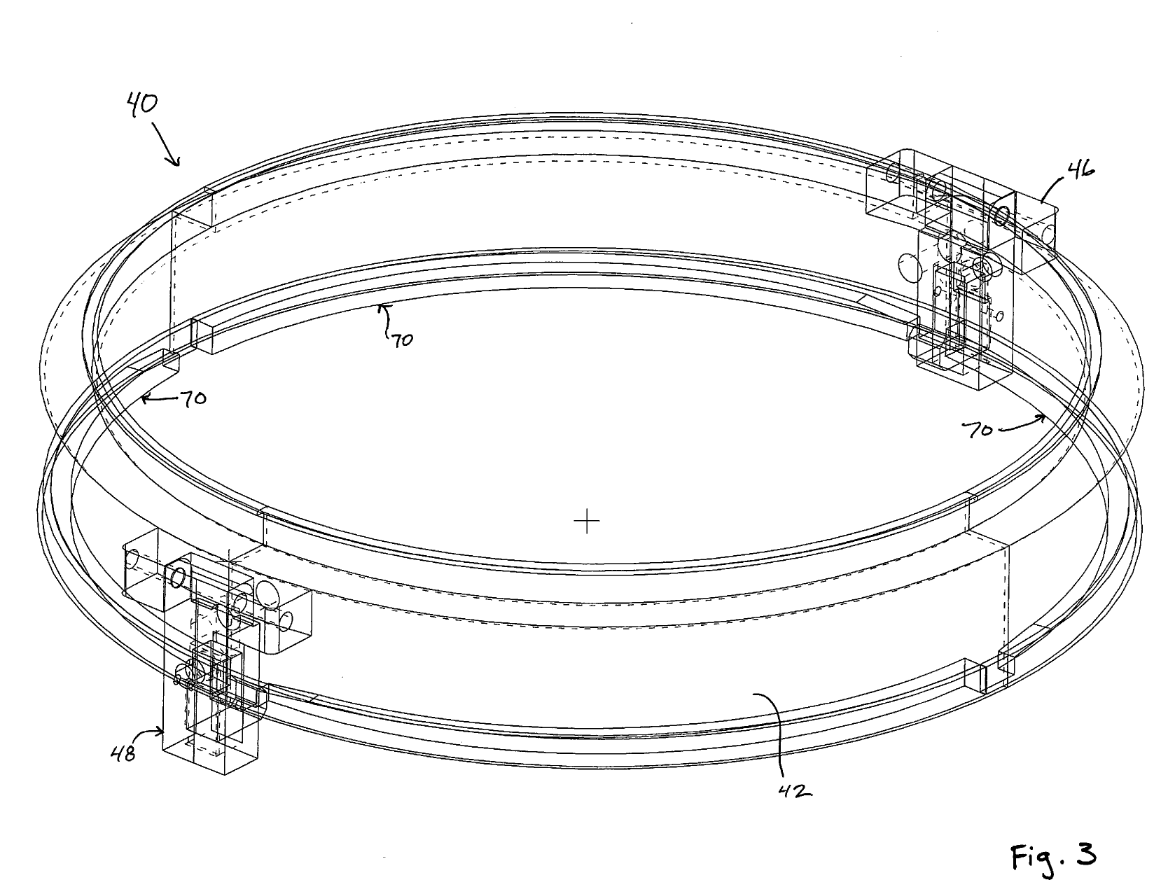

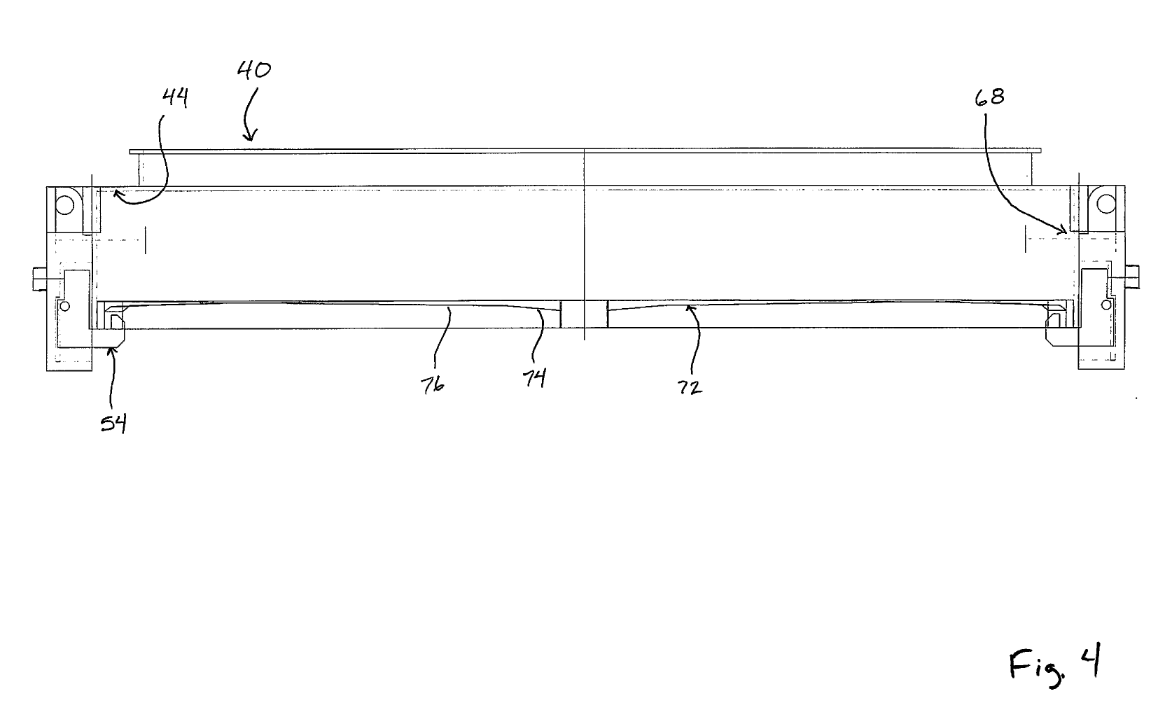

Hoop assembly 40 further includes a plurality of tension lip portions 70 which project inward from annular body 42. As depicted generally in the Figures, hoop assembly 40 includes four tension lip portions 70, arranged circumferentially around annular body 42 and each separated by a clearance space 80. Greater or fewer tension lip portions 70 may be provided as desired. Each tension lip 70 has a generally sloped or angled profile 72 extending from a first end of lip 70 to a second end of lip 70. In one embodiment, profile 72 comprises a linear profile. In another embodiment, profile 72 comprises multiple linear profile portions such as depicted in FIGS. 3-4, wherein profile 72 includes a first portion 74 and a second portion 76, wherein first portion 74 may be sized and selected to provide a coarse level of tuning adjustment while second portion 76 is selected to provide a fine level of tuning adjustment. Profile 72 may include more than two profile portions. In another embodiment, profile 72 comprises one or more curved non-linear profiles, for example an increasing radius or otherwise varying radius along profile 72. Drum assembly 20 further includes a plurality of rollers 84 secured to drum shell 22.

Rollers 84 may comprise a roller bearing or similar as known to persons skilled in the art. Alternatively, rollers 84 may comprise fixed elements having low coefficients of friction, such as polytetrafluoroethylene, acetal, or others as known to persons skilled in the art. The number of rollers 80 for a given drum 20 may be varied as desired. The number of rollers 80 and the number of tension lip portions 70 must be the same.

In operation, replacement and/or tuning of drum head 30 is as follows. Drum head 30 is placed on bearing edge 28 of drum shell 22, and one or more slip rings 90 are placed on drum head 30. Hoop assembly 40 is oriented such that clearance spaces 80 are aligned with rollers 84 and clamp assemblies 48 are in an unlatched position such that clamp assemblies 48 are pivoted away from annular body 42 of hoop assembly 40. Hoop assembly 40 may then be placed over slip rings 90 and drum head 30, such that inner shoulder 44 engages with slip rings 90.

Hoop assembly 40 is then slowly rotated such that tension lips 70 begin to engage with rollers 84. As hoop assembly 40 is rotated, a user may strike skin 32 of drum head 30 to observe the resulting sound. Once the desired sound is obtained from drum assembly 20, the user stops rotating hoop assembly 40 and engages clamp assemblies 48 to lock hoop assembly 40 in place. Clamp assemblies 48 are operated by moving body 50 about upper pivot 52 such that the clamp assemblies are moved toward drum shell 22 and retention means 62 pass through respective channels 68 in annular body 42 until retention means 62 engage against drum head rim 34 and latch portion 56 engages annular body 42.

Removal of drum head 30 is the reverse of installation. Release means 60 is activated to cause latch portion 56 of latch means 54 to disengage from annular body 42, and clamp assemblies 48 are pivoted away from drum shell 22 and annular body 42. Hoop assembly 40 may then be rotated until clearance spaces 80 are aligned with rollers 84, and hoop assembly 40 may be lifted off of drum shell 22.

Various modifications to the embodiments of the inventions may be apparent to one of skill in the art upon reading this disclosure. For example, persons of ordinary skill in the relevant art will recognize that the various features described for the different embodiments of the inventions can be suitably combined, un-combined, and re-combined with other features, alone, or in different combinations, within the spirit of the invention. Likewise, the various features described above should all be regarded as example embodiments, rather than limitations to the scope or spirit of the inventions. Therefore, the above is not contemplated to limit the scope of the present inventions.

Persons of ordinary skill in the relevant arts will recognize that the inventions may comprise fewer features than illustrated in any individual embodiment described above. The embodiments described herein are not meant to be an exhaustive presentation of the ways in which the various features of the inventions may be combined. Accordingly, the embodiments are not mutually exclusive combinations of features; rather, the inventions may comprise a combination of different individual features selected from different individual embodiments, as understood by persons of ordinary skill in the art.

1. An apparatus for retaining and tuning a drum head, the apparatus comprising:
an annular hoop body;
a tension lip disposed on an inner portion of the annular hoop body, the tension lip having an at least partially angled profile,
wherein the apparatus is configured to be installed over a drum head and onto a drum shell such that the profile of the tension lip engages with a roller secured to the drum shell, and further wherein the apparatus is configured to tune the drum head by rotating the annular hoop body with respect to the drum shell; and
a clamp assembly including a retention means and a latch mechanism, the retention means configured to selectively engage the drum head so as to secure the drum head against the drum shell, and the latch mechanism configured to secure the clamp assembly in place.

2. The apparatus of claim 1, wherein the profile of the tension lip comprises a first profile portion and a second profile portion, each profile portion having a different angle.

3. The apparatus of claim 2, wherein the first profile portion comprises a coarse tuning adjustment of the drum head, and wherein the second profile portion comprises a fine tuning adjustment of the drum head.

4. The apparatus of claim 1, wherein the clamp assembly is pivotably coupled to the annular hoop body.

5. The apparatus of claim 1, further comprising a plurality of tension lips disposed on the inner portion of the annular hoop body, each tension lip separated by a clearance space.

6. The apparatus of claim 5, wherein the latch mechanism of the clamp assembly is configured to engage with the clearance space.

7. A kit, comprising:
an apparatus for retaining and tuning a drum head, the apparatus including:
an annular hoop body;
a tension lip disposed on an inner portion of the annular hoop body, the tension lip having an at least partially angled profile; and
a clamp assembly including a retention means and a latch mechanism;
a slip ring configured to be placed between the apparatus and a drum head; and
a plurality of rollers, each roller coupleable to a drum shell.

8. The kit of claim 7, wherein the retention means is configured to selectively engage the drum head so as to secure the drum head against the drum shell, and wherein the latch mechanism is selectively engageable with the annular hoop body to secure the clamp assembly in place.

9. The kit of claim 7, wherein the apparatus is configured to be installed over a drum head and onto a drum shell such that the profile of the tension lip engages with the rollers coupled to the drum shell, and further wherein the apparatus is configured to tune the drum head by rotating the annular hoop body with respect to the drum shell.

10. The kit of claim 7, wherein the profile of the tension lip comprises a first profile portion and a second profile portion, each profile portion having a different angle.

11. The kit of claim 7, further comprising a plurality of tension lips disposed on the inner portion of the annular hoop body, each tension lip separated by a clearance space.

12. The kit of claim 11, wherein the latch mechanism of the clamp assembly is configured to engage with the clearance space.

13. The kit of claim 11, wherein the clearance space is sized to allow the roller to pass therethrough as the apparatus is installed on a drum shell.

14. The kit of claim 11, wherein the number of clearance spaces is equal to the number of rollers.

15. A method of installing and tuning a drum head on a drum shell, the method comprising:
placing a drum head onto a bearing surface of a drum shell;
placing an apparatus onto the drum head, the apparatus including:
an annular hoop body;
a plurality of tension lips disposed on the inner portion of the annular hoop body, each tension lip having an at least partially angled profile and each tension lip separated by a clearance space; and
a clamp assembly,
wherein the clearance space is sized to allow the apparatus to be installed on a drum shell having a roller attached thereto;
tuning the drum head by rotating the apparatus such that the profile of the tension lip engages with the roller secured to the drum shell; and
securing the apparatus and drum head in position by operating the clamp assembly.

16. The method of claim 15, wherein the clamp assembly including a retention means and a latch mechanism, and wherein operating the clamp assembly comprises selectively engaging the retention means against the drum head to secure the drum head against the drum shell and engaging the latch mechanism to secure the clamp assembly in place.

17. The method of claim 16, wherein the latch mechanism of the clamp assembly is configured to engage with the clearance space.

18. The method of claim 15, wherein rotating the apparatus in a first direction tightens the apparatus against the drum shell and tightens the drum head, and rotating the apparatus in an opposite direction loosens the apparatus against the drum shell and loosens the drum head.

19. The method of claim 15, wherein the profile of each tension lip comprises a first profile portion and a second profile portion, each profile portion having a different angle.

20. The method of claim 15, wherein the number of clearance spaces is equal to the number of rollers.
